(19) United States
(12) Patent Application Publication
(10) Pub. No.: US 2008/0218156 A1
(43) Pub. Date: Sep. 11, 2008

(54) MAGNETIC ENCODER INCLUDING MAGNETIC RING HAVING ROUGHNESS

(76) Inventor: Masanori TOMIOKA, Okoyama (JP)

Correspondence Address: WENDEROTH, LIND & PONACK, L.L.P., 2033 K STREET N. W., SUITE 800, WASHINGTON, DC, 20006-1021, US

(21) Appl. No.: 12/120,362

(22) Filed: May 14, 2008

Related U.S. Application Data
(63) Continuation of application No. 11/078,296, filed on Mar. 14, 2005, now abandoned.

(30) Foreign Application Priority Data
Mar. 15, 2004 (JP) 2004-071976

(51) Int. Cl. G01P 3/487

(52) U.S. Cl. 324/174

(57) ABSTRACT

A magnetic encoder includes a metallic reinforcing ring and a magnetic ring attached to the metallic reinforcing ring, and is composed of a mixture of an elastic element and a magnetic material. A front side of the magnetic ring is formed into a roughly uneven surface having a roughness of Ra 0.2 to 10.0 or Ry 2 to 100.0.

This application is a continuation of U.S. application Ser. No. 11/078,296, filed Mar. 14, 2005.

### BACKGROUND OF THE INVENTION

1. Field of the Invention

The present invention relates to a magnetic encoder that includes a metallic reinforcing ring and a magnetic ring attached to the metallic reinforcing ring, wherein the magnetic ring is composed of a mixture of an elastic element and a magnetic material. More particularly, the present invention relates to a magnetic encoder that is easy to be handled and will resist any physical damage that might be caused by scratching and the like, on a front side of the magnetic ring that is magnetized.

2. Prior Art

The magnetic encoder (pulse coder) according to the present invention is a pulse generator ring that may be mounted on an automotive vehicle in order to flexibly control a vehicle safety run control system, such as anti-lock brake system (ABS), traction control (TC) system or vehicle stability control (VSC) system, of a vehicle.

As an example of a location where this magnetic encoder may be mounted, there is a hub flange on a vehicle suspension system that rotates relative to an associated vehicle wheel. The magnetic encoder may be mounted at that location in conjunction with a rotation detection sensor in order to detect a number of revolutions for the associated wheel.

More specifically, the magnetic encoder may be mounted on each of four wheels such as front, rear, right and left wheels, and is capable of detecting any difference in a number of revolutions among these wheels, and turning a drive system or brake system on or off, thereby controlling a behavior of the vehicle so as to ensure that the vehicle can be running with high stability and safety if some emergency occurs.

Generally, magnetic encoder 10 includes following component parts or elements, and is manufactured as follows, for example.

Firstly, a magnetic ring 1 may be obtained by molding a mixture composed of any of ferromagnetic materials such as ferrite, a rare earth element and the like and any of elastic materials such as synthetic rubber, synthetic resin and the like into an appropriate shape. The magnetic ring 1 thus obtained may be magnetized so that N polarity and S polarity can appear alternately in a circumferential direction of the ring. The magnetic ring 1 thus magnetized acts as a multipole magnet.

On the other hand, a metallic reinforcing ring 21 may be formed into a shape having a substantially L-shaped cross section, and the magnetic ring 1 may be attached to an annular flange portion of the metallic reinforcing ring 21. The magnetic ring 1 may be attached to the annular flange portion of the metallic reinforcing ring 21 by using any adhesive medium, for example.

The magnetic ring 1 may be magnetized as before described before it is attached to the metallic reinforcing ring 21, or after it is attached to the metallic reinforcing ring 21. The magnetic encoder 10 may thus be obtained.

The magnetic encoder 10 obtained as before described may be combined with a sealing element 8 as shown in FIG. 6 and used as an encoder-equipped sealing unit 9. The sealing element 8, generally includes a metallic reinforcing ring 3 having a substantially L-shaped cross section, and a lip portion 6 made of any elastic material such as synthetic rubber and supported by the metallic reinforcing ring 3.

The encoder-equipped sealing unit 9 may be mounted on a rolling element such as a bearing as shown in FIGS. 3 and 4. Thereby, the bearing on which the encoder-equipped sealing unit 9 is mounted can be sealed both internally and externally.

Then, as shown in FIG. 4, a rotation detection sensor 7 may be disposed in proximity of the encoder-equipped sealing unit 9 so as to face opposite a front side surface of the magnetic ring 1 in the unit 9. And, as the magnetic encoder 10 is rotated with a rotary element in the bearing, the magnetic ring 1 may produce pulses representing an ever-changing number of revolutions that may be detected by the rotation detection sensor 7. That is to say, the encoder-equipped sealing unit 9 provides both a sealing function and a rotation detecting function.

Prior to being mounted on the bearing as shown in FIGS. 3 and 4, several encoder-equipped sealing units 9, each including the magnetic encoder 10 combined with the sealing element 8 as shown in FIG. 6, are usually placed one over another so that they are oriented in a particular direction as shown in FIG. 7, and may be stored or transported in that state.

If several units 9, each including the magnetic encoder 10 combined with the sealing element 8, are placed one over another so that they are oriented in the particular direction as shown in FIG. 7 and as described above, it may be understood that some parts or elements in another unit 9 located adjacently to one unit 9, such as metallic reinforcing ring 3 or any parts made of elastic material and forming the lip portion in the another unit 9 located adjacently to the one unit 9, may make contact with the front side surface of the magnetic ring 1 of the encoder 10 in the one unit 9 located adjacently to the another unit 9 at the time when these several units 9 are placed one over another as shown in FIG. 7 or transported in that state, or at a time of assembly for the component parts.

When the encoder-equipped sealing units 9 are thus placed in the state shown in FIG. 7, for example, the front side surface of the magnetic ring 1 on the encoder 10 in one unit 9 located on the left side in FIG. 7 may be scratched by the metallic reinforcing ring 3 or any parts made of elastic material and forming the lip portion in another adjacent unit 9 located on the right side in FIG. 7.

If the front side surface of the magnetic ring 1 is scratched as described above, the magnetic ring 1 that acts as a multipole magnet will not produce pulses precisely, and therefore the magnetic encoder 10 including such magnetic ring 1 will not be able to detect a number of revolutions accurately.

Even if such scratches are very small, any magnetic encoder 10 that contains such a defective magnetic ring should be treated as unacceptable both visually and commercially.

When several encoder-equipped sealing units 9 are stored in the state in which they are placed one over another as shown in FIG. 7, it has been described that the magnetic ring 1 on the encoder 10 in one unit 9 may make contact with the metallic reinforcing ring 3 or any parts made of elastic material and forming the lip portion in another unit 9 located adjacently to the one unit 9. When this occurs, and if the magnetic ring 1 has a smooth front surface, the magnetic ring 1 in one unit 9 and the metallic reinforcing ring 3 in another adjacent unit 9 will tend to contact each other more tightly by increased magnetic attraction.

For example, in case the metallic reinforcing ring 3 in adjacent another unit 9 is made of magnetic material, the magnetic ring 1 in one unit 9 and the metallic reinforcing ring 3 in adjacent another unit 9 will tend to attract each other more strongly by magnetic attraction, thereby causing these units to contact each other much more tightly. If an attempt is made to detach the units 9, 9 in this case, it will become more difficult to separate them from each other.

Similarly, when the magnetic ring 1 in one unit 9 makes contact with any parts made of elastic material and forming the lip portion in another adjacent unit 9, these units will tend to contact each other more tightly because the magnetic ring 1 is also based on elastic material, thereby making it more difficult to separate the units from each other.

When several encoder-equipped sealing units 9, each including the magnetic encoder 10 combined with the sealing element 8, are loaded into a magazine or the like in a state in which those units 9 are placed one over another so that they are oriented in the particular direction as shown in FIG. 7, it will be difficult to remove each individual unit 9 from the magazine and then mount it on a bearing mechanically by using any mechanical mounting machine because the units are magnetically attached to each other. As a result, a mechanical mounting operation will become remarkably less efficient.

In order to eliminate problems associated with the prior art magnetic encoder as described above, it was proposed to prevent the front side surface of the magnetic ring 1 from suffering from physical damage such as scratches by increasing a hardness of the magnetic ring 1 or by forming a coating layer 4 on the front side surface of the magnetic ring 1 as shown in FIG. 6.

Also, in order to solve a problem of making it difficult to detach two adjacent units 9 and 9 from each other due to magnetic attraction when they are placed adjacently to each other as described above, the applicant of the present application proposed to provide a magnetic encoder that is constructed as shown in FIG. 7 (WO03/014601A1). In this construction, the magnetic encoder 10 may be combined with a sealing element 8 wherein the sealing element 8 includes an elastic element 17 that is formed on a side of a flange portion of metallic reinforcing ring 3 of the sealing element 8 facing opposite the magnetic encoder 10 as shown in FIG. 7.

It should be noted, however, that this construction still has a problem of cohesion because the magnetic ring 1 is based on an elastic element, and remains yet to be improved in order to effectively solve the problem of making it difficult to detach the two adjacent units from each other due to magnetic attraction while preventing the front side surface of the magnetic ring 1 from suffering from damage such as scratches.

### SUMMARY OF THE INVENTION

An object of the present invention is therefore to provide an effective solution for eliminating the problem of making it difficult to detach two adjacent encoder-equipped sealing units, which comprises the sealing element 8 combined with magnetic encoder 10 including magnetic ring 1, from each other due to magnetic attraction while preventing the front side surface of the magnetic ring 1 from suffering from damage such as scratches.

That is to say, an object of the present invention is to provide a magnetic encoder that has a simplified construction, and can eliminate the problem of making it difficult to detach the two adjacent encoder-equipped sealing units from each other due to magnetic attraction while preventing the front side surface of the magnetic ring 1 from suffering from damage such as scratches.

Specifically, it is an object of the present invention to propose a construction which can prevent the front side surface of the magnetic ring 1 from suffering from damage such as scratches, and also prevent any two adjacent encoder-equipped sealing units, each comprising the sealing element 8 combined with magnetic encoder 10 including magnetic ring 1, from contacting each other so tightly that it is difficult to detach them from each other due to magnetic attraction when they are placed one over the other and oriented in the particular direction as shown in FIG. 7.

For example, when these encoder-equipped sealing units are loaded into a magazine in a state in which they are placed one over the other and oriented in the particular direction as shown in FIG. 7, each individual unit can be removed from the magazine easily, and then mounted into a bearing smoothly. Also prevented is the front side surface of the magnetic ring 1 from suffering from damage such as scratches.

In order to solve the problems described above, and to achieve the before described object, one aspect of the present invention is to provide a magnetic encoder that includes a metallic reinforcing ring and a magnetic ring attached to the metallic reinforcing ring. The magnetic ring is composed of a mixture of an elastic element and a magnetic material, and a front side surface of the magnetic ring is formed into a roughly uneven surface having a roughness of Ra 0.2 to 10.0 or Ry 2 to 100.0.

In the above, Ra refers to surface roughness (arithmetic average roughness) as defined in JIS B0601-1994, and Ry refers to surface roughness (maximum height) as defined in JIS B0601-1994.

Experiments conducted by the inventor of the present application show that a magnetic encoder that includes a magnetic ring whose front side surface is formed into a roughly uneven surface having a roughness of Ra 0.2 to 10.0 or Ry 2 to 100.0 can prevent the front side surface of the magnetic ring from suffering from scratches, and can also prevent any two adjacent encoder-equipped sealing units, each comprising a sealing element combined with a magnetic encoder including the magnetic ring, from being contacted so tightly due to magnetic attraction that it is difficult to easily detach one from another when an attempt is made to detach them from each other.

In the above description, the magnetic ring can be molded so that its front side surface can have the roughly uneven surface having the roughness of Ra 0.2 to 10.0 or Ry 2 to 100.0 by using a metal mold cavity having a molding surface previously finished by a blast working process, an electron discharge working process or an etching process. As described more specifically, the metal mold cavity used for molding the magnetic ring may have its molding surface previously formed into a roughly uneven surface by the blast working process, electron discharge working process or etching process, and then the roughly uneven surface of the metal mold cavity may be transferred to the magnetic ring so that a reversed roughly uneven surface 5 having a roughness of Ra 0.2 to 10.0 or Ry 2 to 100.0 can appear on the front side surface of the magnetic ring 1 when it is molded by using the metal mold cavity.

In accordance with the magnetic encoder of the present invention, the front side surface of the magnetic ring 1 is formed into the roughly uneven surface S having the roughness of Ra 0.2 to 10.0 or Ry 2 to 100.0. Thus, when several encoder-equipped sealing units 9, each including the magnetic encoder 10 combined with the sealing element 8, such as two adjacent units 9 in the example shown in FIG. 5, are placed one over the other so that they are oriented in a particular direction as shown in FIG. 5, the front side surface of the magnetic ring 1 can effectively be prevented from suffering from damage such as scratches even when it is contacted by a metallic reinforcing ring 3 of sealing element 8 in adjacent unit 9. As there is no risk that any scratches would be caused on the front side surface of the magnetic ring 1, the magnetic ring 1 acting as a multipole magnet can produce pulses accurately. Accordingly, a number of revolutions can be detected accurately.

A risk that the magnetic ring 1 in one unit 9 would adhere to another unit 9 located adjacently to the one unit 9 so tightly because the magnetic ring 1 is based on an elastic material can also be avoided because there is the roughly uneven surface on the front side of the magnetic ring 1. Thus, when several encoder-equipped sealing units 9, such as the two adjacent units 9 and 9 in the example shown in FIG. 5, each of which includes the magnetic encoder 10 combined with the sealing element 8, are placed one over the other so that they are oriented in the particular direction as shown in FIG. 5, there is no risk that these two adjacent units 9 and 9 cannot be detached from each other because of magnetic attraction when an attempt is made to separate them.

As a result, when several encoder-equipped sealing units 9 are loaded into a magazine in the state shown in FIG. 5, each individual unit 9 can be removed from the magazine easily, and then can be mounted into a bearing smoothly.

### BRIEF DESCRIPTION OF THE DRAWINGS

FIG. 1 is a cross sectional view of an example of a magnetic encoder of the present invention as viewed in an oblique direction, although some non-essential parts or elements are not shown;

FIG. 2 is a cross sectional view of an example of an encoder-equipped sealing unit that includes the magnetic encoder of the present invention and a sealing element combined with the magnetic encoder, although some non-essential parts or elements are not shown;

FIG. 3 is a cross sectional view illustrating how the encoder-equipped sealing unit, that includes the magnetic encoder of the present invention and the sealing element combined with the magnetic encoder, is mounted on a bearing;

FIG. 4 is a part of FIG. 3 on an enlarged scale for illustrating how the encoder-equipped sealing unit, that includes the magnetic encoder of the present invention and the sealing element combined with the magnetic encoder, is mounted on the bearing;

FIG. 5 is a cross sectional view illustrating several encoder-equipped sealing units, each including the magnetic encoder of the present invention and a sealing element combined with the magnetic encoder, that are placed one over another so that they are oriented in a particular direction, although some non-essential parts or elements are not shown;

FIG. 6 is a cross sectional view of a conventional encoder-equipped sealing unit that includes a conventional magnetic encoder and sealing element combined with the conventional magnetic encoder, although some non-essential parts or elements are not shown; and

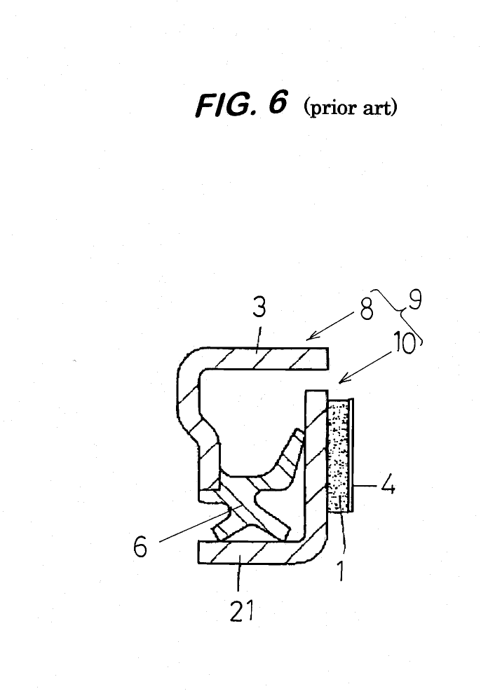

FIG. 7 is a cross sectional view illustrating several encoder-equipped sealing units, each including the conventional magnetic encoder and sealing element combined with the conventional magnetic encoder, that are placed one over another so that they are oriented in a particular direction, although some non-essential parts or elements are not shown.

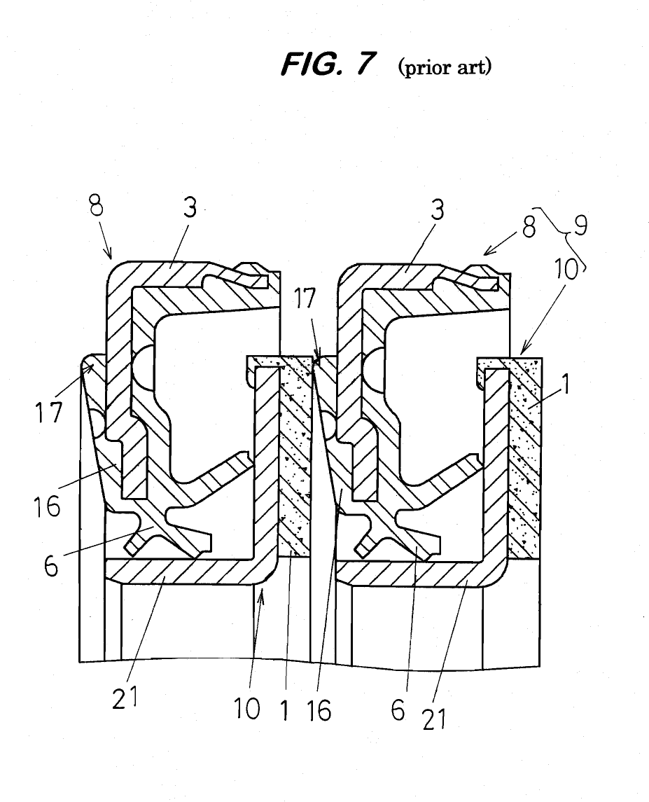

### DETAILED DESCRIPTION OF THE PREFERRED EMBODIMENTS

A magnetic encoder 10 of the present invention includes following component parts or elements, and is manufactured as follows, for example.

Firstly, how a magnetic ring 1, which is one of the component parts of the magnetic encoder 10, may be formed is described.

As it is known in the relevant field, an elastic material such as synthetic rubber, synthetic resin and the like is prepared, to which any of ferromagnetic materials in a powdery form, such as ferrite, a rare earth element and the like, is added. Then, the elastic material thus obtained is vulcanized and molded into a magnetic ring 1, which has an annular shape, by using a metal mold cavity.

In the prior art, it is usual practice that a molding surface of the metal mold cavity is previously finished so that it can have a roughness of below Ra 0.2, and the elastic material is then molded by such metal molding cavity into a magnetic ring 1, which has an annular shape, so that its front side surface can have a roughness of below Ra 0.2.

According to the present invention, the metal mold cavity has its molding surface previously finished so that it can have a roughness of Ra 0.2 to 10.0 or Ry 2 to 100, and is used to mold elastic material into a magnetic ring 1, which has an annular shape, so that a roughly uneven surface having a roughness of Ra 0.2 to 10.0 or Ry 2 to 100 can appear on its front side surface.

Specifically, as vulcanized molding occurs by using such metal mold cavity, the molding surface of the metal mold cavity can be transferred to the surface of the magnetic ring 1 so that roughly uneven surface 5 having the roughness of Ra 0.2 to 10.0 or Ry 2 to 100 results on the front side surface of the magnetic ring.

Then, the magnetic ring 1 is magnetized so that S polarity and N polarity can appear on its front side alternately in a circumferential direction of the magnetic ring.

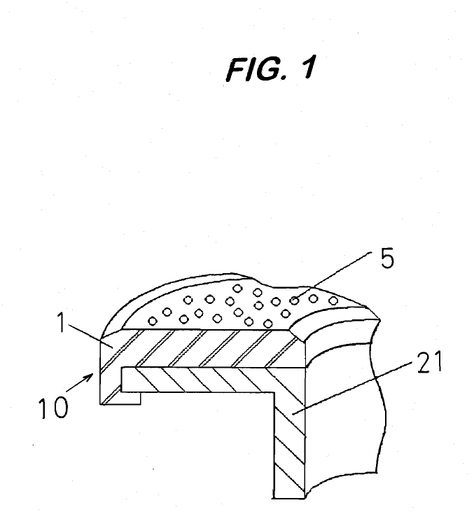

Finally, the front side surface of the magnetic ring 1 has the roughly uneven surface 5 similar to that of the metal mold cavity after it has been transferred to the magnetic ring 1. That is, the molding surface of the metal mold cavity has the roughness of Ra 0.2 to 10.0 or Ry 2 to 100 as described above, and the roughly uneven surface 5 of the magnetic ring 1 also has the roughness of Ra 0.2 to 10.0 or Ry 2 to 100 as shown in FIG. 1.

The magnetic ring 1 whose front side surface is formed into the roughly uneven surface having the roughness of Ra 0.2 to 10.0 or Ry 2 to 100 is thus obtained.

The magnetic ring 1 thus obtained is then attached to an annular flange portion of a metallic reinforcing ring 21 usually made of iron or stainless steel by using any appropriate adhesive medium. The magnetic encoder 10 of the present invention is thus obtained.

When the elastic material containing the ferromagnetic material in powdery form is vulcanized and molded into the annular magnetic ring 1 by using the metal mold cavity described above, the metallic reinforcing ring 21 may also be placed into the metal mold cavity at the same time where the annular magnetic ring 1 may be bonded to the annular flange portion of the reinforcing ring 21 while it is being vulcanized and molded.

Specifically, the metallic reinforcing ring 21 as well as the elastic material containing the ferromagnetic material in powdery form may be placed into the metal mold cavity where the elastic material may be vulcanized and molded into the annular magnetic ring 1 while at the same time the annular magnetic ring 21 may be bonded to the annular flange portion of the reinforcing ring 21. Then, the magnetic ring 1 thus obtained may be magnetized so that S polarity and N polarity can appear on its front side alternately in the circumferential direction of the magnetic ring 1. Finally, the magnetic encoder 10 that contains the magnetic ring 1 and reinforcing ring 21 can be obtained.

In the embodiment shown in FIG. 1, it should be noted that the reinforcing ring 21 is formed into a shape having a substantially L-shaped cross section, and includes a cylindrical portion extending in a vertical direction in FIG. 1 and an annular flange portion extending at a right angle from an end of the cylindrical portion.

In the example of the magnetic encoder shown in FIG. 1, the annular magnetic ring 1 is attached to the annular flange portion of the reinforcing ring 21, but it may be attached to a peripheral surface of the cylindrical portion perpendicular to the flange portion.

The molding surface of the metal mold cavity that may be transferred to the front side surface of the magnetic ring 1 while it is being molded may be formed into a roughly uneven surface having the roughness of Ra 0.2 to 10.0 or Ry 2 to 100.0 by using any of a working process such as a blast working process, electron discharge working process and etching process. The blast working process is used to blow a jet of abrasive media against a surface of a work at high speeds, and form a roughly uneven surface having an appropriate roughness by utilizing this impact force. The electron discharge working process is used to produce sparks electrically, and form tiny holes on the surface of a metal work by removing any conductive substances from the work. The etching process is used to dissolve a metal surface of a metal work by using any chemical, and form a pattern of leather, rocks, sands, pears and the like on the surface of the work.

In the embodiment described so far, the molding surface of the metal mold cavity is previously formed to provide a roughly uneven surface, and the front side surface of the magnetic ring 1 is formed to present the roughly uneven surface 5 by transferring a pattern to the magnetic ring 1 while it is being molded. As a variation of the embodiment, the front side surface of the magnetic ring 1 may be formed to provide the roughly uneven surface directly by using any of the working processes mentioned above. Which method is chosen may depend upon particular requirements.

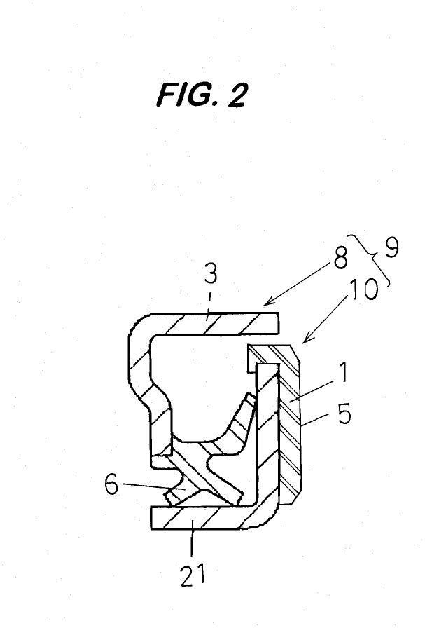

The magnetic encoder 10 of the present invention may be used alone as shown in FIG. 1, but may be combined with a sealing element 8 as shown in FIG. 2, thereby providing an encoder-equipped sealing unit 9.

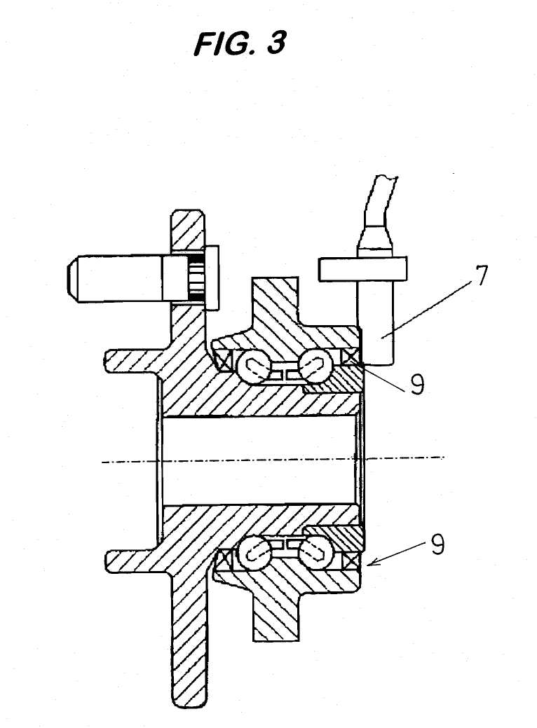

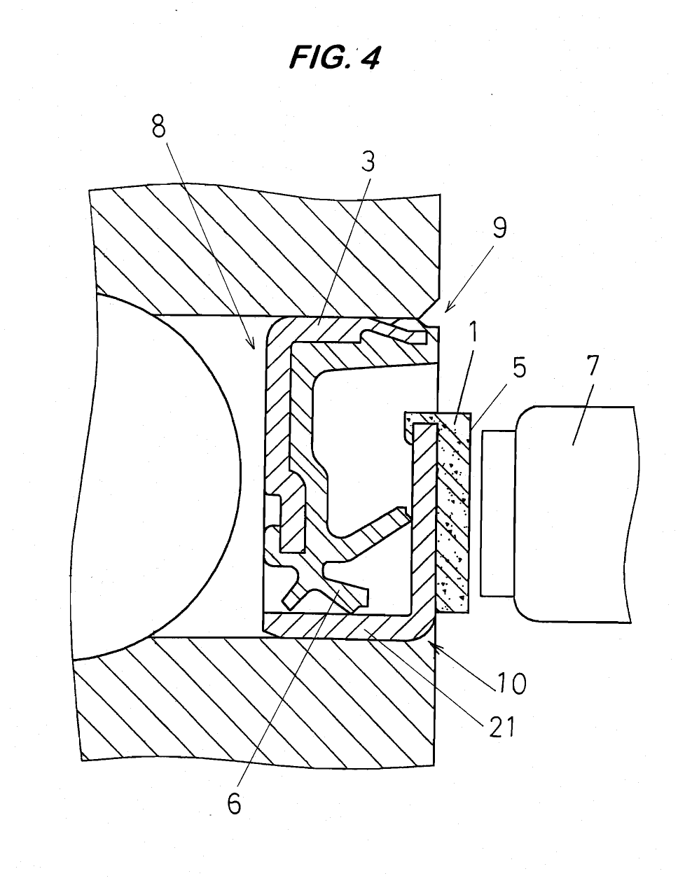

FIG. 3 is a cross sectional view illustrating how the encoder-equipped sealing unit 9, including the magnetic encoder 10 of the present invention combined with the sealing element 8 as shown in FIG. 2, is mounted onto a bearing of an automotive vehicle. As shown in FIG. 4 on an enlarged scale, a rotation detection sensor 7 is located in proximity of the front side of the magnetic ring 1 of the magnetic encoder 10.

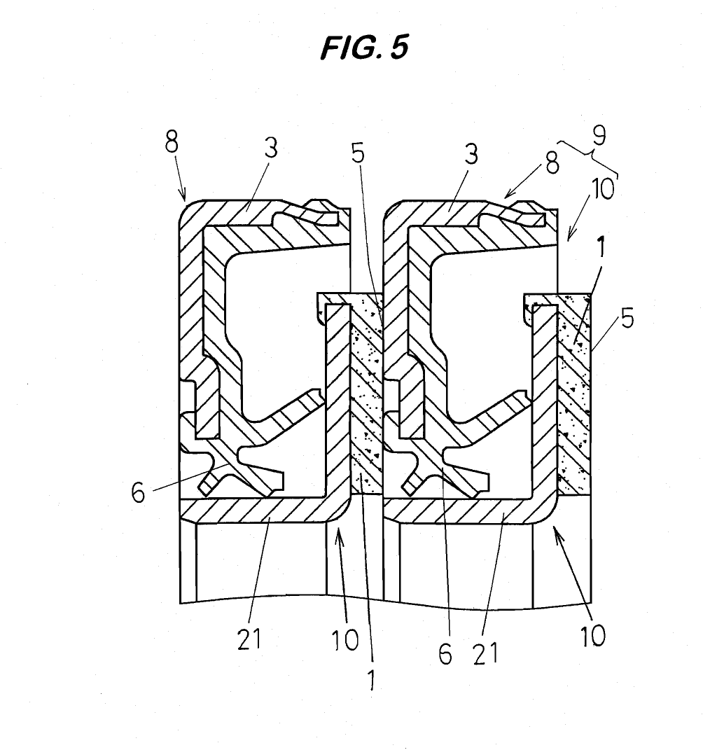

When several encoder-equipped sealing units 9, each of which includes the magnetic encoder 10 of the present invention combined with the sealing element 8 as shown in FIG. 2, are placed one over another so that they are oriented in a particular direction as shown in FIG. 5, the magnetic ring 1 of the magnetic encoder 10 in the unit 9 located on the left side may make contact with a rear side of a flange portion of a metallic reinforcing ring 3 or a rear side of a part made of elastic material forming lip portion 6 in an adjacent unit 9 located on the right side. According to the magnetic encoder 10 of the present invention, in such case, a contact area can be reduced by presence of the roughly uneven surface 5 formed on the front side surface of the magnetic ring 1. This prevents any two adjacent units 9 and 9 from adhering to each other tightly by magnetic attraction.

Experiments conducted by the inventor of the present application, when several encoder-equipped sealing units 9, each of which includes the magnetic encoder 10 of the present invention combined with the sealing element 8 as shown in FIG. 2, are placed one over another so that they are oriented in the particular direction as shown in FIG. 5 and loaded into a magazine in that state, and then each individual unit 9 is removed from the magazine and mounted on the bearing by using the appropriate mounting machine, this removal can be accomplished easily and smoothly. Visually, no scratches appear on the front side surface of any magnetic ring 1 after it has been removed and then mounted on each respective bearing.

As one application of the magnetic encoder of the present invention, it may be used to provide an encoder-equipped sealing unit as described so far by combining it with the sealing element 8. Several such units may be loaded into a magazine in a state in which they are placed one over another and oriented in the particular direction. When an attempt is made to remove each individual unit from the magazine and then mount it on a bearing by using an appropriate mounting machine, this can be accomplished easily and smoothly without causing any cohesion between any two adjacent units. When several such units are loaded and stored in a magazine, or transported, or when each individual unit is removed from each respective magazine and mounted, no scratches will be produced on the front side surface of each individual magnetic ring. Thus, the magnetic encoder can retain its pulse generating precision, and can detect a number of revolutions accurately when the encoder-equipped sealing unit including such magnetic encoder is mounted on a bearing of an automotive vehicle.

Although only preferred embodiments have been illustrated and described specifically so far, it may be appreciated that many modifications and variations of the present invention are possible in light of the above teachings and without departing from the spirit and intended scope of the invention.

What is claimed is:

1. A magnetic encoder comprising:
a metallic reinforcing ring; and
a magnetic ring attached to said metallic reinforcing ring, said magnetic ring having a front surface facing away from said metallic reinforcing ring, said front surface having a roughness of Ra 0.2 to 10.0 or Ry 2 to 100.0.

2. The magnetic encoder according to claim 1, wherein
said magnetic ring is composed of a mixture of an elastic material and a magnetic material.

3. The magnetic encoder according to claim 2, wherein
said front surface is provided with said roughness of Ra 0.2 to 10.0 or Ry 2 to 100.0 by molding said mixture of said elastic material and said magnetic material, into said magnetic ring, in a mold having a mold surface, corresponding to said front surface of said magnetic ring, exhibiting a roughness of Ra 0.2 to 10.0 or Ry 2 to 100.0 such that the roughness of the mold surface is imparted to said mixture.

4. The magnetic encoder according to claim 3, wherein
the mold surface is made to exhibit the roughness of Ra 0.2 to 10.0 or Ry 2 to 100.0 by being subjected to one of blast working, electron discharge working and etching.

5. The magnetic encoder according to claim 1, wherein
said front surface is provided with said roughness of Ra 0.2 to 10.0 or Ry 2 to 100.0 by molding material, into said magnetic ring, in a mold having a mold surface, corresponding to said front surface of said magnetic ring, exhibiting a roughness of Ra 0.2 to 10.0 or Ry 2 to 100.0 such that the roughness of the mold surface is imparted to the material.

6. The magnetic encoder according to claim 5, wherein
the mold surface is made to exhibit the roughness of Ra 0.2 to 10.0 or Ry 2 to 100.0 by being subjected to one of blast working, electron discharge working and etching.
